(19) United States
(12) Patent Application Publication
(10) Pub. No.: US 2023/0306773 A1
(43) Pub. Date: Sep. 28, 2023

(54) INFORMATION PROCESSING APPARATUS, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventors: Masanori YOSHIZUKA, Kanagawa (JP); Junichi SHIMIZU, Kanagawa (JP); Shintaro ADACHI, Kanagawa (JP); Akinobu YAMAGUCHI, Kanagawa (JP); Akane ABE, Kanagawa (JP); Naomi TAKAHASHI, Kanagawa (JP); Kunihiko KOBAYASHI, Kanagawa (JP)

(73) Assignee: FUJIFILM BUSINESS INNOVATION CORP., Tokyo (JP)

(21) Appl. No.: 17/887,773

(22) Filed: Aug. 15, 2022

(30) Foreign Application Priority Data
Mar. 25, 2022 (JP) 2022-050717

(51) Int. Cl. G06V 30/416; G06V 30/18; G06V 30/19; G06V 30/14

(52) U.S. Cl. CPC G06V 30/416; G06V 30/18105; G06V 30/19013; G06V 30/1448; G06V 30/1916

(57) ABSTRACT

An information processing apparatus includes a processor configured to: separate a header part and a body part from a read image obtained by reading a facsimile document which is a document received by facsimile; and switch preprocessing in accordance with a header recognition result which is a recognition result obtained through character recognition on the header part, the preprocessing being performed before character recognition on the body part.

### CROSS-REFERENCE TO RELATED APPLICATIONS

This application is based on and claims priority under 35 USC 119 from Japanese Patent Application No. 2022-050717 filed Mar. 25, 2022.

### BACKGROUND

### (i) Technical Field

The present disclosure relates to an information processing apparatus, a non-transitory computer readable medium, and an information processing method.

### (ii) Related Art

For example, Japanese Unexamined Patent Application Publication No. 2017-151493 describes an image processing apparatus which outputs character information obtained through recognition performed in the upright direction, in which image data is oriented upright. The upright direction is obtained in a shorter processing time than the case in which image information of the entire document is used to determine the upright direction of the document. The image processing apparatus includes an acquisition unit and an output unit. In an image formed on a document, the acquisition unit acquires image information of a second region for detecting the upright direction of the image. The second region is predetermined on the basis of a criterion different from that for a first region in which character recognition is performed. The output unit outputs character information of the first region. The character information is obtained through recognition performed in the upright direction, which is obtained from the acquired image information, of the image.

Japanese Unexamined Patent Application Publication No. 2019-128839 describes an image processing apparatus which suppresses reduction of accuracy in determination of the upright direction, when a predetermined specific region does not contain characters suitable for determination of the upright direction. The image processing apparatus includes a layout analysis unit, an extraction unit, a character recognition unit, and an upright-direction determination unit. The layout analysis unit performs layout analysis on image data. The extraction unit extracts figures and tables from the image data by using the result of the layout analysis. The character recognition unit performs character recognition on a partial area having a high probability of presence of strings in consideration of the extracted figures and tables. The upright-direction determination unit determines the upright direction of the image data by using the result of the character recognition.

Japanese Patent No. 6070976 describes an image processing apparatus which enables suppression of the amount of processing in conversion of the document format of a read printed document. The image processing apparatus includes an image-object separating unit, an N-up layout determination unit, a print-direction determination unit, and a document-format conversion unit. The image-object separating unit separates image objects from a read printed document. The N-up layout determination unit determines the N-up layout of the read printed document on the basis of the arrangement of the image objects separated by the image-object separating unit. The print-direction determination unit determines the print direction of each page, which is determined by the N-up layout determination unit, on the basis of the features of the image objects separated by the image-object separating unit. The document-format conversion unit converts the document format of the read printed document on the basis of the determination results from the N-up layout determination unit and the print-direction determination unit. If the N-up layout determination unit determines that the read printed document has multiple N-up layouts, the document-format conversion unit selects the N-up layout having the fewest pages, separates the pages from each other, and converts the document format page by page.

There is a technique for performing character recognition on a read image, which is obtained by reading a facsimile document received by facsimile, to obtain character information of the body part of the read image. A facsimile document often contains character distortion, character loss, and the like. Thus, preprocessing for correcting character distortion, character loss, and the like may be performed before character recognition to achieve improvement of accuracy in character recognition.

Character distortion, character loss, and the like in a facsimile document depend, for example, on the model of the transmission-source apparatus, from which the facsimile document has been transmitted. However, the same preprocessing is performed on body parts regardless of, for example, the models of transmission-source apparatuses, resulting in insufficient correction and difficulty in performing accurate character recognition on the body parts.

### SUMMARY

Aspects of non-limiting embodiments of the present disclosure relate to an information processing apparatus, a non-transitory computer readable medium, and an information processing method which enable character recognition to be performed on body parts with accuracy, compared with the case in which the same preprocessing is performed on body parts regardless of, for example, the models of transmission-source apparatuses.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: separate a header part and a body part from a read image obtained by reading a facsimile document which is a document received by facsimile; and switch preprocessing in accordance with a header recognition result which is a recognition result obtained through character recognition on the header part, the preprocessing being performed before character recognition on the body part.

### BRIEF DESCRIPTION OF THE DRAWINGS

Exemplary embodiments of the present disclosure will be described in detail based on the following figures, wherein:

FIG. 1 is a diagram illustrating an exemplary configuration of an information processing system according to a first exemplary embodiment;

FIG. 2 is a block diagram illustrating an exemplary electrical configuration of an image forming apparatus according to the first exemplary embodiment;

FIG. 3 is a diagram for describing key-value extraction according to the exemplary embodiment;

FIG. 4 is a diagram illustrating exemplary FAX images obtained before and after preprocessing according to the exemplary embodiment;

FIG. 5 is a block diagram illustrating an exemplary functional configuration of an image forming apparatus according to the first exemplary embodiment;

FIG. 6 is a diagram illustrating an exemplary preprocessing-model switching table according to the first exemplary embodiment;

FIG. 7 is a diagram for describing how to separate a header part and a body part from a FAX image, according to the exemplary embodiment;

FIG. 8 is a flowchart of an exemplary process performed by using an information processing program according to the first exemplary embodiment;

FIG. 9 is a diagram illustrating an exemplary menu screen and an exemplary preprocessing setting screen according to a second exemplary embodiment;

FIG. 10 is a diagram illustrating an exemplary confidence-factor derivation result for preprocessing models, according to the second exemplary embodiment;

FIG. 11 is a flowchart of an exemplary process performed by using an information processing program according to the second exemplary embodiment;

FIG. 12 is a diagram illustrating an exemplary preprocessing-model switching table according to a third exemplary embodiment;

FIG. 13 is a diagram for describing the feature value of character regions included in a body part, according to the third exemplary embodiment;

FIG. 14 is a flowchart of an exemplary process performed by using an information processing program according to the third exemplary embodiment;

FIG. 15 is a diagram illustrating an exemplary database according to a fourth exemplary embodiment;

FIG. 16 is a flowchart of an exemplary process performed by using an information processing program according to the fourth exemplary embodiment; and

FIG. 17 is a flowchart of an exemplary process performed by using an information processing program according to a modified example of the fourth exemplary embodiment.

### DETAILED DESCRIPTION

Referring to the drawings, exemplary embodiments for carrying out the technique of the present disclosure will be described in detail below. Components and processes, which have identical operations, effects, and functions, are designated with identical reference numerals in all the drawings, and repeated description may be skipped as appropriate. Each drawing is merely schematic to the extent that the technique of the present disclosure is fully understood. Therefore, the technique of the present disclosure is not limited only to the illustrated examples. In the present exemplary embodiment, a configuration, which is not directly related to the present disclosure, or a known configuration may not be described.

### First Exemplary Embodiment

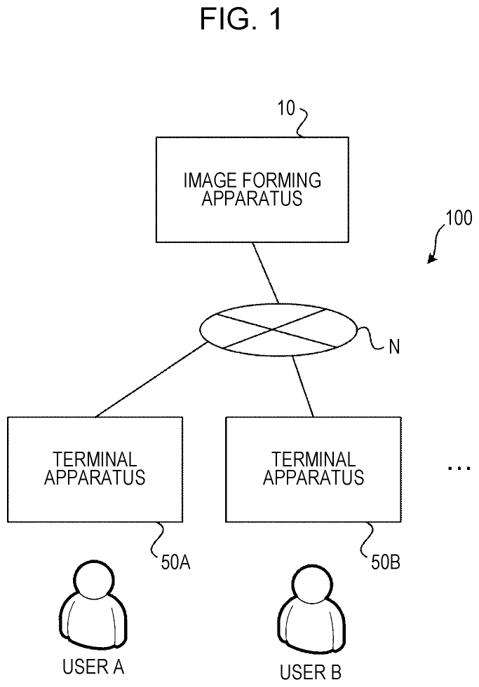

FIG. 1 is a diagram illustrating an exemplary configuration of an information processing system 100 according to a first exemplary embodiment.

As illustrated in FIG. 1, the information processing system 100 according to the first exemplary embodiment includes an image forming apparatus 10 and multiple terminal apparatuses 50A, 50B, etc. The image forming apparatus 10 is an exemplary information processing apparatus. The information processing apparatus according to the first exemplary embodiment may be other than the image forming apparatus 10, and, for example, may be a general-purpose computer, such as a server computer or a personal computer (PC).

The image forming apparatus 10 performs functions, which relate to images, in accordance with instructions from users. The image forming apparatus 10 is connected to the terminal apparatuses 50A, 50B, etc., which are used by users, over a network N. As the network N, for example, the Internet, a local area network (LAN), or a wide area network (WAN) may be used. The connection form of the network N has no limitation, and any one of wired connection, wireless connection, or a combination of wired connection and wireless connection may be used.

For example, the image forming apparatus 10 has a scan function of reading, as image data, an image written on a recording medium such as a sheet, a print function of forming, on a recording medium, an image represented by image data, and a copy function of forming, on a different recording medium, the same image as the image formed on a recording medium. The copy function, the print function, and the scan function are exemplary image processing performed by the image forming apparatus 10.

As the terminal apparatuses 50A, 50B, etc., for example, various devices, such as a PC, a smartphone, and a tablet terminal, used by users are used. Assume that a terminal apparatus used by user A is the terminal apparatus 50A, and a terminal apparatus used by user B is the terminal apparatus 50B. When the terminal apparatuses 50A, 50B, etc., are not necessarily differentiated, these are also called terminal apparatuses 50 collectively. The terminal apparatuses 50 are information equipment used by users. The terminal apparatuses 50 may be any types of information equipment as long as it has a data storage function, a data communication function, and a data display function.

Users transmit, over the network N to the image forming apparatus 10, image data, which is generated by using the terminal apparatuses 50, so as to cause the image forming apparatus 10 to perform image processing. Alternatively, users, who store image data in a portable storage medium, such as a Universal Serial Bus (USB) memory or a memory card, may go to the image forming apparatus 10, and may connect the portable storage medium to the image forming apparatus 10 so as to cause the image forming apparatus 10 to perform image processing the users want. Alternatively, users, who carry documents on which either one or both of characters and images are written, may go to the image forming apparatus 10, and may make the image forming apparatus 10 read the documents so as to cause the image forming apparatus 10 to perform image processing the users want.

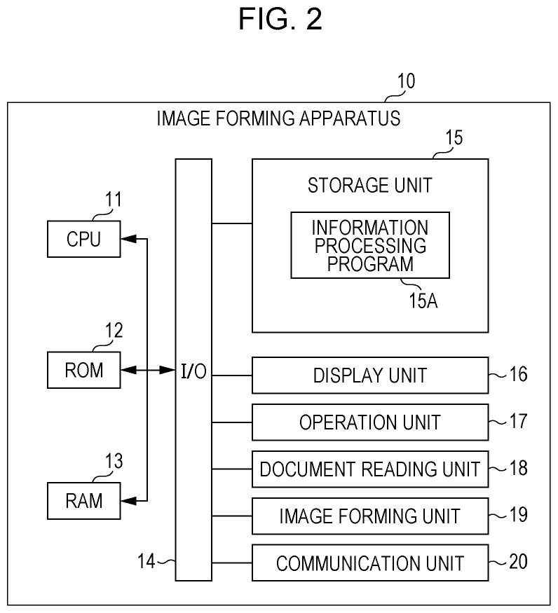

FIG. 2 is a block diagram illustrating an exemplary electrical configuration of the image forming apparatus 10 according to the first exemplary embodiment.

As illustrated in FIG. 2, the image forming apparatus 10 according to the first exemplary embodiment includes a central processing unit (CPU) 11, a read only memory (ROM) 12, a random access memory (RAM) 13, an input/output interface (I/O) 14, a storage unit 15, a display unit 16, an operation unit 17, a document reading unit 18, an image forming unit 19, and a communication unit 20.

The CPU 11, the ROM 12, the RAM 13, and the I/O 14 are connected to each other through a bus. The functional units, including the storage unit 15, the display unit 16, the operation unit 17, the document reading unit 18, the image forming unit 19, and the communication unit 20, are connected to the I/O 14. These functional units are capable of communicating with the CPU 11 through the I/O 14 mutually.

The CPU 11, the ROM 12, the RAM 13, and the I/O 14 form a controller. The controller may be formed as a sub-controller which controls some operations of the image forming apparatus 10, or may be formed as a part of the main controller which controls the operations of the entire image forming apparatus 10. As part or all of each block of the controller, for example, an integrated circuit such as a large scale integration (LSI) or an integrated circuit (IC) chipset is used. For each of the blocks, an individual circuit may be used. Alternatively, a circuit, in which some or all of the blocks are integrated, may be used. The blocks may be provided as an integral unit, or some blocks may be provided separately. In each of the blocks, part of the block may be provided separately. For integration of the controller, not only an LSI but also a dedicated circuit or a general-purpose processor may be used.

As the storage unit 15, for example, a hard disk drive (HDD), a solid state drive (SSD), or a flash memory may be used. The storage unit 15 stores an information processing program 15A according to the first exemplary embodiment. The information processing program 15A may be stored in the ROM 12.

For example, the information processing program 15A may be installed in advance in the image forming apparatus 10. The information processing program 15A may be stored in a nonvolatile storage medium, or may be distributed over the network N to be installed in the image forming apparatus 10 as appropriate. Examples of the nonvolatile storage medium may include a compact disc read only memory (CD-ROM), a magneto-optical disk, an HDD, a digital versatile disc read only memory (DVD-ROM), a flash memory, and a memory card.

As the display unit 16, for example, a liquid crystal display (LCD) or an organic light-emitting diode display is used. The display unit 16 may include a touch panel as an integral unit. For the operation unit 17, for example, various keys, such as a numeric keypad and a start key, are provided. The display unit 16 and the operation unit 17, which serve as an operation panel, receive instructions about various image processing functions and settings from users of the image forming apparatus 10. Examples of the various instructions include an instruction to start reading a document, an instruction to start copying a document, and an instruction to perform printing on print data held by the image forming apparatus 10. The display unit 16 displays various types of information, such as the result of a process performed in accordance with an instruction received from a user, and a notification about the process.

The document reading unit 18 takes documents, one sheet by one sheet, which are put on a sheet feed table of an automatic document feeder (not illustrated) provided in an upper portion of the image forming apparatus 10, and reads the taken documents optically to obtain image data. Alternatively, the document reading unit 18 optically reads a document, which is put on a document platen such as platen glass, to obtain image data.

The image forming unit 19 forms, on a sheet which is an exemplary recording medium, an image based on image data obtained through reading by using the document reading unit 18, or image data obtained through a print instruction transmitted from an external apparatus. In the description below, as a method of forming an image, an electrophotographic system is used as an example, but another system such as an inkjet system may be employed.

When the method of forming an image is an electrophotographic system, the image forming unit 19 includes a photoreceptor drum, a charging device, an exposure device, a developing device, a transfer device, and a fixing device. The charging device applies a voltage to the photoreceptor drum, and charges the surface of the photoreceptor drum. The exposure device exposes, to light in accordance with image data, the photoreceptor drum charged by the charging device, and thus forms an electrostatic latent image on the photoreceptor drum. The developing device develops the electrostatic latent image, which is formed on the photoreceptor drum, by using toner, and thus forms a toner image on the photoreceptor drum. The transfer device transfers, to a sheet, the toner image formed on the photoreceptor drum. The fixing device applies heat and pressure to the toner image, which has been transferred to a sheet, for fixing.

The communication unit 20 is a communication interface for establishing a connection with the network N, such as the Internet, a LAN, or a WAN, and may communicate with the terminal apparatus 50 over the network N.

The image forming apparatus 10 according to the first exemplary embodiment has a function of performing optical character recognition (OCR) processing on a facsimile (hereinafter referred to as “FAX”) image of a form to specify a string serving as a key and extract, as a value, a string located near the key (hereinafter, the function is referred to as “key-value extraction”).

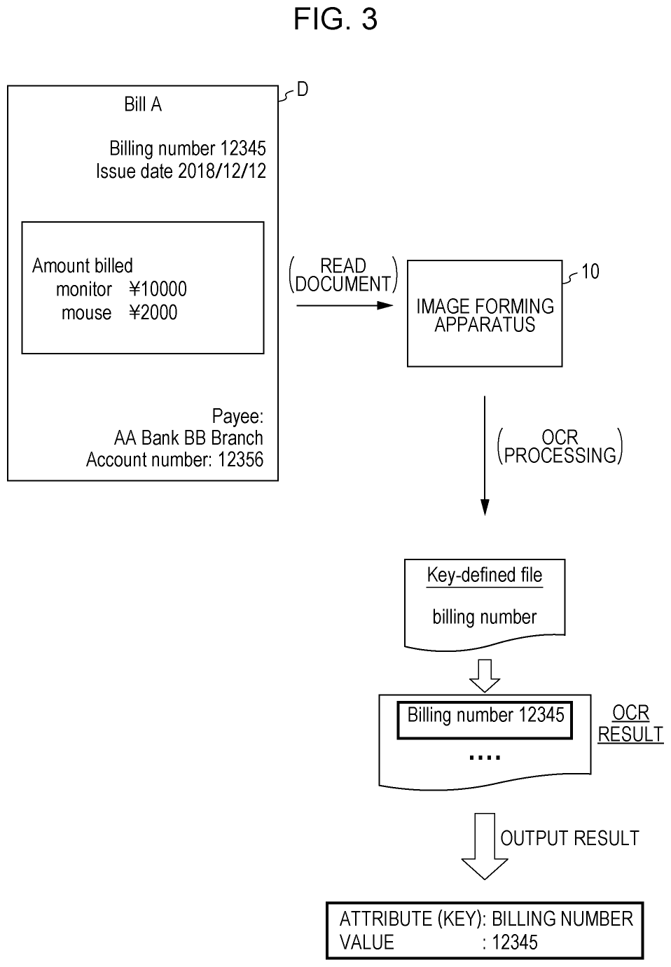

FIG. 3 is a diagram for describing key-value extraction according to the first exemplary embodiment.

As illustrated in FIG. 3, the image forming apparatus 10 reads a certain form D by using the document reading unit 18, and performs OCR processing on the read image obtained through reading. In the OCR processing, for example, for the form D (read image) which contains “Billing number 12345”, “billing number” is registered as a key in advance in a key-defined file. The read image is subjected to OCR processing, and “billing number”, which serves as a key, is found. Then, “12345”, which is located near “billing number” which has been found, is extracted as a value.

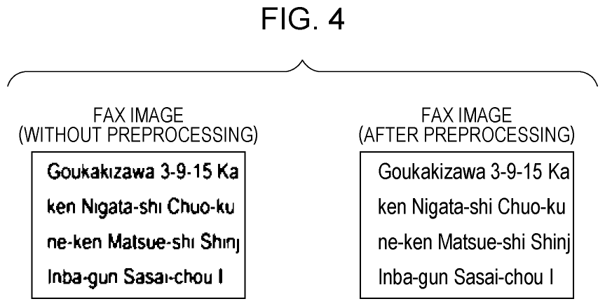

In the key-value extraction on a FAX image, to improve accuracy of the OCR processing, preprocessing may be performed before the OCR processing. An example of the preprocessing is, for example, a process of correcting character distortion, character loss, and the like in a FAX image, as illustrated in FIG. 4.

FIG. 4 is a diagram illustrating exemplary FAX images before and after the preprocessing according to the first exemplary embodiment.

As illustrated in FIG. 4, preprocessing is performed on a FAX image. Thus, character distortion, character loss, and the like in the FAX image are corrected, improving the accuracy of character recognition in the OCR processing performed downstream.

As described above, character distortion, character loss, and the like in a FAX image depend on the model of the transmission-source apparatus from which the FAX is transmitted. However, the same preprocessing is performed on body parts before the OCR processing regardless of the models or the like of the transmission-source apparatuses. Therefore, the correction may be insufficient, and it is difficult to perform OCR processing on body parts with accuracy.

Accordingly, the image forming apparatus 10 according to the first exemplary embodiment separates a header part and a body part from a read image obtained by reading a FAX document which is a document received by FAX. Then, the image forming apparatus 10 switches the preprocessing, which is performed before character recognition on the body part, in accordance with the recognition result obtained through character recognition on the header part.

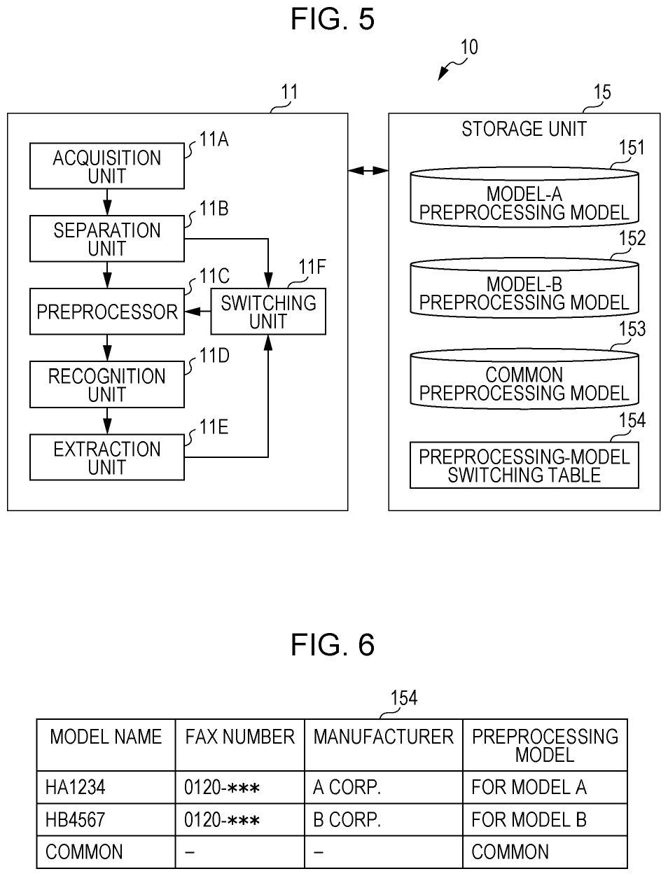

Specifically, the CPU 11 of the image forming apparatus 10 according to the first exemplary embodiment loads, for execution, the information processing program 15A, which is stored in the storage unit 15, onto the RAM 13, thus functioning as the units illustrated in FIG. 5. The CPU 11 is an exemplary processor.

FIG. 5 is a block diagram illustrating an exemplary functional configuration of the image forming apparatus 10 according to the first exemplary embodiment.

As illustrated in FIG. 5, the CPU 11 of the image forming apparatus 10 according to the first exemplary embodiment functions as an acquisition unit 11A, a separation unit 11B, a preprocessor 11C, a recognition unit 11D, an extraction unit 11E, and a switching unit 11F.

The storage unit 15 stores a model-A preprocessing model 151, a model-B preprocessing model 152, a common preprocessing model 153, and a preprocessing-model switching table 154. The model-A preprocessing model 151, the model-B preprocessing model 152, the common preprocessing model 153, and the preprocessing-model switching table 154 may be stored in an external storage device which may be accessed by the image forming apparatus 10.

The model-A preprocessing model 151 is a trained model generated by performing machine learning on FAX images and supervised data of model A, which are used as training data, in association with model A from which FAX images are transmitted. The model-A preprocessing model 151 is a model for performing optimal preprocessing on FAX images of model A.

The model-B preprocessing model 152 is a trained model generated by performing machine learning on FAX images and supervised data of model B, which are used as training data, in association with model B from which FAX images are transmitted. The model-B preprocessing model 152 is a model for performing optimal preprocessing on FAX images of model B.

The common preprocessing model 153 is a trained model generated by performing machine learning on FAX images and supervised data, which are used as training data, regardless of models. The common preprocessing model 153 is a model for performing preprocessing on FAX images regardless of models. The technique itself of performing preprocessing on FAX images by using a preprocessing model is a known technique.

FIG. 6 is a diagram illustrating an exemplary preprocessing-model switching table 154 according to the first exemplary embodiment.

In the preprocessing-model switching table 154 in FIG. 6, the model name, the FAX number, and the manufacturer are registered in advance in association with the preprocessing model. The model name is model information designating the model of a transmission-source apparatus from which FAX documents are transmitted. The manufacturer is manufacturer information designating the manufacturer (maker) of the model of the transmission-source apparatus. The FAX number is a FAX number of the transmission-source apparatus.

The acquisition unit 11A acquires a FAX image obtained by reading a FAX document which is a document received through fax. A FAX image is, for example, an image obtained by the document reading unit 18 reading a FAX document.

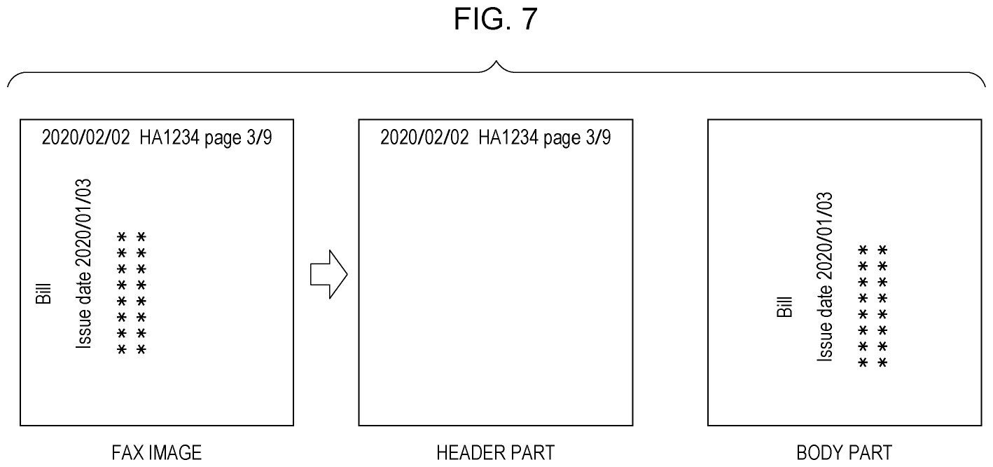

For example, as illustrated in FIG. 7, the separation unit 11B separates a header part and a body part from a FAX image obtained by the acquisition unit 11A.

FIG. 7 is a diagram for describing how to separate a header part and a body part from a FAX image, according to the first exemplary embodiment.

As illustrated in FIG. 7, a header part and a body part are separated from a FAX image. Specifically, for example, a FAX image is subjected to object separation, and it is determined, for each of the four periphery parts, whether strings are present in a certain area (for example, 100 pixels). When it is determined that strings are present in a header part, an image only for the header part and an image only for the body part, which is obtained by masking the header part, are generated.

The preprocessor 11C performs preprocessing on the header part, for example, by using the common preprocessing model 153.

The recognition unit 11D performs OCR processing on the header part, which has been subjected to the preprocessing by the preprocessor 11C, and performs character recognition on the header part.

The extraction unit 11E extracts header information, which is information included in the header part, from the header recognition result obtained through character recognition performed by the recognition unit 11D. The header information includes at least one of the following types of information: model information, manufacturer information, and FAX number information. The model information designates the model of a transmission-source apparatus from which the FAX document has been transmitted. The manufacturer information designates the manufacturer (maker) of the model of the transmission-source apparatus. The FAX number information designates a FAX number of the transmission-source apparatus. For example, in the example in FIG. 7, a model name, “HA1234”, which is exemplary model information, is extracted from the header recognition result.

When the header information includes two or more types of information among the model information, the manufacturer information, and the FAX number information, the extraction unit 11E extracts the content of header information in the order of the model information, the manufacturer information, and the FAX number information, which is predetermined priority. That is, if header information includes the model information and the manufacturer information, the model information is extracted preferentially. If header information includes the manufacturer information and the FAX number information, the manufacturer information is extracted preferentially. The FAX number information is obtained in FAX reception. Thus, the FAX number information may be obtained without OCR processing.

The switching unit 11F switches the preprocessing, which is performed before a body part is subjected to OCR processing, in accordance with the header information extracted by the extraction unit 11E. Specifically, in the example in FIG. 7, a model name, “HA1234”, which is exemplary model information, is extracted. Thus, the preprocessing-model switching table 154 illustrated in FIG. 6 is referred to, and switching to the model-A preprocessing model 151 is made.

The preprocessor 11C uses the preprocessing model, which is obtained through switching performed by the switching unit 11F, to perform preprocessing on the body part. In the example in FIGS. 6 and 7, the model-A preprocessing model 151 is used to perform preprocessing on the body part.

The recognition unit 11D performs OCR processing on the body part, which has been subjected to preprocessing by the preprocessor 11C, to perform character recognition on the body part, and performs, for example, the key-value extraction described in FIG. 3.

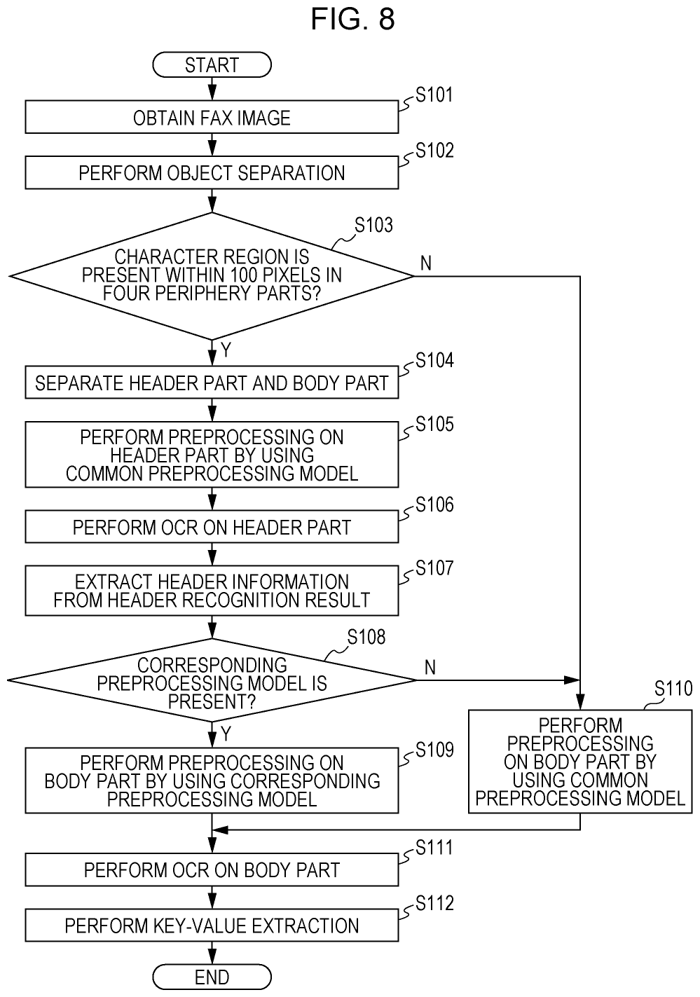

Referring to FIG. 8, the operation of the image forming apparatus 10 according to the first exemplary embodiment will be described.

FIG. 8 is a flowchart of an exemplary process performed by using the information processing program 15A according to the first exemplary embodiment.

When the image forming apparatus 10 is instructed to perform the key-value extraction, the CPU 11 runs the information processing program 15A to perform the steps described below.

In step S101 in FIG. 8, the CPU 11 obtains a FAX image, for example, as illustrated in FIG. 7.

In step S102, the CPU 11 performs object separation on the FAX image obtained in step 5101.

In step S103, the CPU 11 determines, for example, for each of the four periphery parts of the FAX image, whether a character region is present within 100 pixels, from the result obtained through the object separation in step S102. If it is determined that a character region is present, that is, if it is determined that a header part is present (in the case of positive determination), the process proceeds to step S104. If it is determined that a character region is not present, that is, if it is determined that a header part is not present (in the case of negative determination), the process proceeds to step S110.

In step S104, the CPU 11 masks the header part, and generates a mask image having only the body part. Thus, the CPU 11 separates the header part and the body part from the FAX image, for example, as illustrated in FIG. 7. That is, an image only for the header part and an image only for the body part are generated.

In step S105, the CPU 11 performs preprocessing on the header part, which is obtained through the separation in step S104, for example, by using the common preprocessing model 153.

In step S106, the CPU 11 performs OCR processing on the header part which has been subjected to preprocessing in step S105.

In step S107, the CPU 11 extracts header information from the header recognition result obtained through OCR processing on the header part in step S106. As described above, the header information includes at least one of the following types of information; the model information, the manufacturer information, and the FAX number information. When the header information includes two or more types of information, information is extracted in the order of the model information, the manufacturer information, and the FAX number information preferentially. For example, in the example in FIG. 7, a model name, “HA1234”, which is exemplary model information, is extracted.

In step S108, the CPU 11 determines whether a preprocessing model corresponding to the header information (for example, the model information) extracted in step S107 is present. If it is determined that such a preprocessing model is present (in the case of positive determination), the process proceeds to step S109. If it is determined that such a preprocessing model is not present (in the case of negative determination), the process proceeds to step S110. Specifically, the preprocessing-model switching table 154 illustrated in FIG. 6 is referred to. Since the model name, “HA1234”, which is exemplary model information, corresponds to the model-A preprocessing model 151, it is determined that the corresponding preprocessing model is present.

In step S109, the CPU 11 performs preprocessing on the body part by using the corresponding preprocessing model (for example, the model-A preprocessing model 151).

In contrast, in step S110, the CPU 11 performs preprocessing on the body part by using the common preprocessing model 153.

In step S111, the CPU 11 performs OCR processing on the body part which has been subjected to preprocessing in step S109 or step S110.

In step S112, the CPU 11 performs the key-value extraction, which is described in FIG. 3, from the result from the OCR processing in step Sill, and ends the series of processes performed according to the information processing program 15A.

Thus, according to the first exemplary embodiment, the preprocessing, which is performed before character recognition on the body part, is switched in accordance with the recognition result (such as model information) obtained through character recognition on the header part. Thus, compared with the case in which the same preprocessing is performed on body parts regardless of the models or the like of the transmission-source apparatuses, body parts may be subjected to character recognition with accuracy.

### Second Exemplary Embodiment

In a second exemplary embodiment, a form in which occurrence of false recognition of characters included in a header part is suppressed will be described.

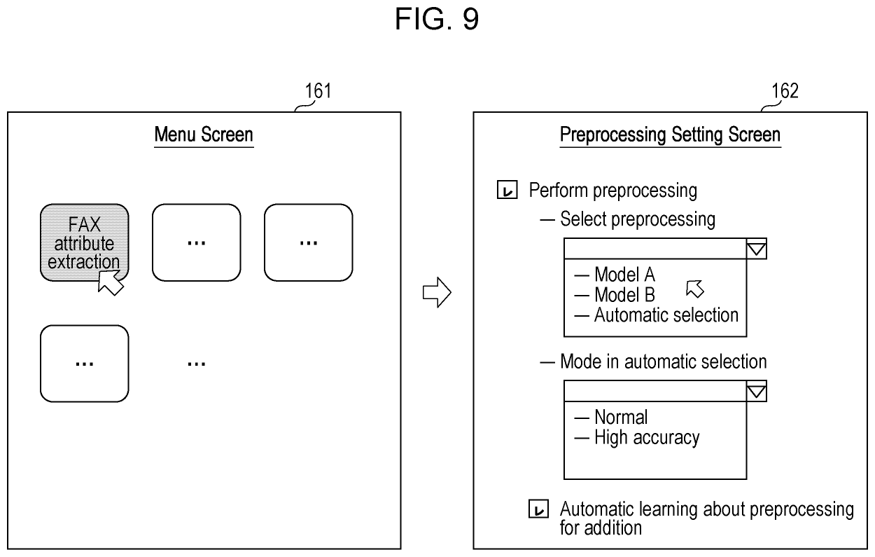

FIG. 9 is a diagram illustrating an exemplary menu screen 161 and an exemplary preprocessing setting screen 162 according to the second exemplary embodiment. The menu screen 161 and the preprocessing setting screen 162 are displayed, for example, on the display unit 16.

As illustrated in FIG. 9, when a user presses a “FAX attribute extraction” button on the menu screen 161, a transition to the preprocessing setting screen 162 is made. On the preprocessing setting screen 162, “Perform preprocessing” and “Automatic learning about preprocessing for addition” are selectable. When “Perform preprocessing” is selected, “Select preprocessing” is selectable. In “Select preprocessing”, any of “Model A”, “Model B”, and “Automatic selection” may be selected. When “Automatic selection” is selected, “Normal” or “High accuracy” may be selected. “Normal” indicates a mode in which the common preprocessing model 153 is applied to a header part. “High accuracy” indicates a mode in which multiple preprocessing models (in the example in FIG. 9, the model-A preprocessing model 151, the model-B preprocessing model 152, and the common preprocessing model 153) are applied to a header part. “Automatic learning about preprocessing for addition” will be described below.

Like the image forming apparatus 10 described in the first exemplary embodiment, the CPU 11 of an image forming apparatus (hereinafter referred to as an “image forming apparatus 10A”) according to the second exemplary embodiment functions as the acquisition unit 11A, the separation unit 11B, the preprocessor 11C, the recognition unit 11D, the extraction unit 11E, and the switching unit 11F. The differences between the image forming apparatus 10A according to the second exemplary embodiment and the image forming apparatus 10 according to the first exemplary embodiment will be described below.

When “High accuracy” is selected on the preprocessing setting screen 162, the preprocessor 11C performs multiple types of preprocessing on a header part. Specifically, all the model-A preprocessing model 151, the model-B preprocessing model 152, and the common preprocessing model 153 are used to perform multiple types of preprocessing on a header part.

The recognition unit 11D performs OCR processing on each of the results, which are obtained through multiple types of preprocessing performed on a header part by the preprocessor 11C, and selects the header recognition result, having the highest recognition accuracy, from the obtained header recognition results. Specifically, the recognition unit 11D selects the header recognition result, whose confidence factor indicating recognition accuracy is the highest, from the header recognition results. The confidence factor is one of index values indicating the certainty of a character recognition result. The higher the confidence factor is, the higher the recognition accuracy is. The confidence factor is derived by using a known method.

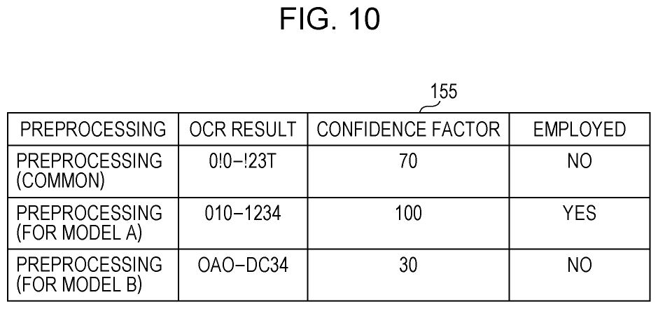

FIG. 10 is a diagram illustrating an exemplary confidence-factor derivation result 155 for preprocessing models, according to the second exemplary embodiment.

The confidence-factor derivation result 155 illustrated in FIG. 10 shows OCR results (header recognition results) and confidence factors for the respective preprocessing models, that is, the common preprocessing model 153, the model-A preprocessing model 151, and the model-B preprocessing model 152. In this case, the model-A preprocessing model 151, having the highest confidence factor, is selected.

The extraction unit 11E extracts header information (such as model information), which is included in a header part, from the header recognition result selected by the recognition unit 11D.

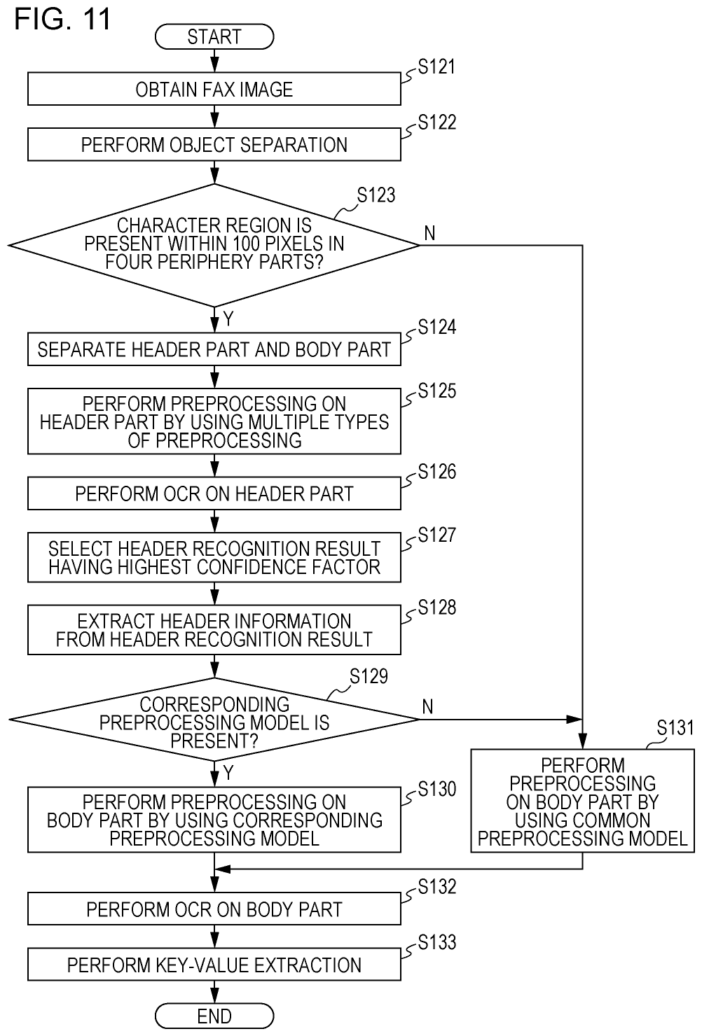

Referring to FIG. 11, the operation of the image forming apparatus 10A according to the second exemplary embodiment will be described.

FIG. 11 is a flowchart of an exemplary process performed by using the information processing program 15A according to the second exemplary embodiment.

When the image forming apparatus 10A is instructed to perform the key-value extraction, the CPU 11 runs the information processing program 15A, and performs the steps described below. In the example, “High accuracy” mode has been selected on the preprocessing setting screen 162 illustrated in FIG. 9.

In step S121 in FIG. 11, the CPU 11 obtains a FAX image, for example, as illustrated in FIG. 7.

In step S122, the CPU 11 performs object separation on the FAX image obtained in step 5121.

In step S123, the CPU 11 determines, for example, for each of the four periphery parts of the FAX image, whether a character region is present within 100 pixels, from the result obtained through the object separation in step S122. If it is determined that a character region is present, that is, if it is determined that a header part is present (in the case of positive determination), the process proceeds to step S124. If it is determined that a character region is not present, that is, if it is determined that a header part is not present (in the case of negative determination), the process proceeds to step S131.

In step S124, the CPU 11 masks the header part, and generates a mask image having only the body part. Thus, the CPU 11 separates the header part and the body part from the FAX image, for example, as illustrated in FIG. 7. That is, an image only for the header part and an image only for the body part are generated.

In step S125, the CPU 11 performs preprocessing on the header part, which is obtained through the separation in step S124, by using multiple types of preprocessing models, for example, the model-A preprocessing model 151, the model-B preprocessing model 152, and the common preprocessing model 153.

In step S126, the CPU 11 performs OCR processing on the results of the header part which are obtained through multiple types of preprocessing in step S125.

In step S127, the CPU 11 derives confidence factors from the header recognition results obtained through OCR processing on the preprocessing results of the header part in step S126, and selects the header recognition result having the highest confidence factor.

In step S128, the CPU 11 extracts header information from the header recognition result selected in step S127. As described above, the header information includes at least one of the following types of information: the model information, the manufacturer information, and the FAX number information. When the header information includes two or more of these types of information, extraction is performed in the order of the model information, the manufacturer information, and the FAX number information preferentially. For example, in the example in FIG. 7, a model name, “HA1234”, which is exemplary model information, is extracted.

In step S129, the CPU 11 determines whether a preprocessing model corresponding to the header information (for example, the model information) extracted in step S128 is present. If it is determined that such a preprocessing model is present (in the case of positive determination), the process proceeds to step S130. If it is determined that such a preprocessing model is not present (in the case of negative determination), the process proceeds to step S131. Specifically, the preprocessing-model switching table 154 in FIG. 6 is referred to. Since the model name, “HA1234”, which is exemplary model information, corresponds to the model-A preprocessing model 151, it is determined that the corresponding preprocessing model is present.

In step S130, the CPU 11 performs preprocessing on the body part by using the corresponding preprocessing model (for example, the model-A preprocessing model 151).

In contrast, in step S131, the CPU 11 performs preprocessing on the body part by using the common preprocessing model 153, and the process proceeds to step S132.

In step S132, the CPU 11 performs OCR processing on the body part which has been subjected to preprocessing in step S130 or step S131.

In step S133, the CPU 11 performs the key-value extraction, which is described in FIG. 3 as an example, from the result of the OCR processing in step S132, and ends the series of processes according to the information processing program 15A.

Thus, according to the second exemplary embodiment, after multiple types of preprocessing are performed on a header part, OCR processing is performed, and the header recognition result, having the highest recognition accuracy, is selected. Thus, occurrence of false recognition of characters included in a header part is suppressed.

### Third Exemplary Embodiment

In a third exemplary embodiment, a form in which, when a header part is not present or header information fails to be obtained from a header part due to influence of noise or the like, the normal mode or the high-accuracy mode is selectable as a mode for preprocessing will be described.

Like the image forming apparatus 10 described in the first exemplary embodiment, the CPU 11 of an image forming apparatus (hereinafter referred to as an “image forming apparatus 10B”) according to the third exemplary embodiment functions as the acquisition unit 11A, the separation unit 11B, the preprocessor 11C, the recognition unit 11D, the extraction unit 11E, and the switching unit 11F. The differences between the image forming apparatus 10B according to the third exemplary embodiment and the image forming apparatus 10 according to the first exemplary embodiment will be described.

When a header part is not present or header information fails to be obtained from a header part, the preprocessor 11C makes any of the following modes selectable: the normal mode in which a specific preprocessing (for example, the common preprocessing model 153) is performed on a body part; a high-accuracy mode in which the preprocessing is switched in accordance with the feature value of character regions included in the body part. The normal mode is an exemplary first mode. The high-accuracy mode is an exemplary second mode. The normal mode and the high-accuracy mode may be selected on the preprocessing setting screen 162 illustrated in FIG. 9.

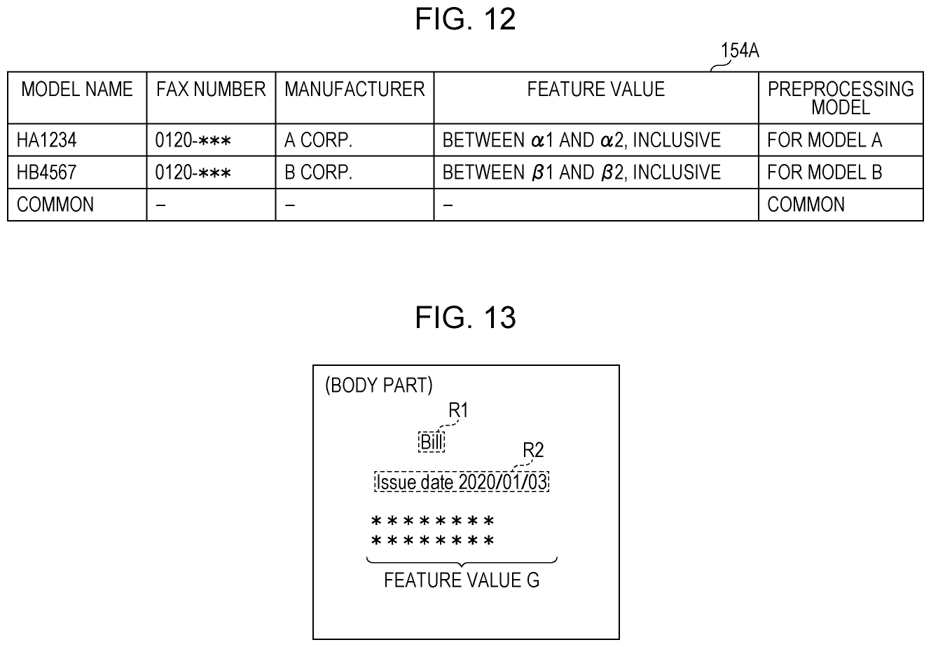

FIG. 12 is a diagram illustrating an exemplary preprocessing-model switching table 154A according to the third exemplary embodiment. The preprocessing-model switching table 154A is stored, for example, in the storage unit 15.

In the preprocessing-model switching table 154A illustrated in FIG. 12, in addition to the model name, the FAX number, and the manufacturer, the feature value is further registered in advance in association with the preprocessing model. The feature value indicates, for example, the ratio between the white pixels and the black pixels in areas obtained by surrounding, with circumscribed rectangles, character regions included in a body part.

FIG. 13 is a diagram for describing the feature value of character regions included in a body part according to the third exemplary embodiment.

As illustrated in the example in FIG. 13, the feature value indicates the ratio between the white pixels and the black pixels in areas R1 and R2 which are obtained by surrounding, with circumscribed rectangles, character regions included in the body part. Assume that the ratio between white pixels and black pixels in this case is a feature value G.

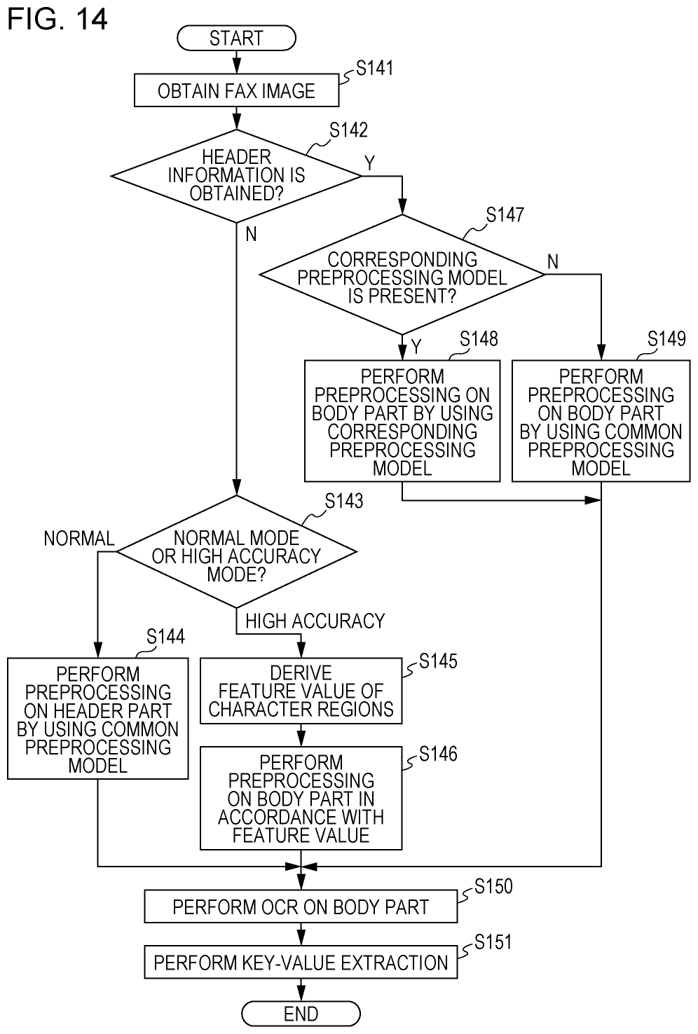

Referring to FIG. 14, the operation of the image forming apparatus 10B according to the third exemplary embodiment will be described.

FIG. 14 is a flowchart of an exemplary process performed by using the information processing program 15A according to the third exemplary embodiment.

When the image forming apparatus 10B is instructed to perform the key-value extraction, the CPU 11 runs the information processing program 15A, and performs the steps described below.

In step S141 in FIG. 14, the CPU 11 obtains a FAX image, for example, as illustrated in FIG. 7.

In step S142, the CPU 11 determines whether header information is successfully obtained from the FAX image obtained in step S141. If it is determined that header information fails to be obtained, that is, if it is determined that a header part is not present or if header information fails to be obtained from the header part due to influence of noise or the like (in the case of negative determination), the process proceeds to step S143. If it is determined that header information is successfully obtained (in the case of positive determination), the process proceeds to step S147.

In step S143, the CPU 11 determines whether the normal mode or the high-accuracy mode has been selected on the preprocessing setting screen 162 illustrated in FIG. 9 as an example. If it is determined that the normal mode has been selected (in the case of normal), the process proceeds to step S144. If it is determined that the high-accuracy mode has been selected (in the case of high accuracy), the process proceeds to step S145.

In step S144, the CPU 11 performs preprocessing on the body part, for example, by using the common preprocessing model 153, and the process proceeds to step S150.

In step S145, the CPU 11 derives the feature value of character regions included in the body part. For example, as illustrated in FIG. 13, the feature value G is derived.

In step S146, the CPU 11 performs preprocessing on the body part in accordance with the feature value derived in step S145, and the process proceeds to step S150. Specifically, on the basis of the feature value G illustrated in FIG. 13, for example, the preprocessing-model switching table 154A illustrated in FIG. 12 is referred to, and a corresponding preprocessing model is selected.

In contrast, in step S147, the CPU 11 determines whether a preprocessing model corresponding to the header information (for example, the model information) obtained in step S142 is present. If it is determined that such a preprocessing model is present (in the case of positive determination), the process proceeds to step S148. If it is determined that such a preprocessing model is not present (in the case of negative determination), the process proceeds to step S149. Specifically, the preprocessing-model switching table 154A illustrated in FIG. 12 is referred to. Since the model name, “HA1234”, which is exemplary model information, corresponds to the model-A preprocessing model 151, it is determined that the corresponding preprocessing model is present.

In step S148, the CPU 11 performs preprocessing on the body part by using the corresponding preprocessing model (for example, the model-A preprocessing model 151), and the process proceeds to step S150.

In contrast, in step S149, the CPU 11 performs preprocessing on the body part by using the common preprocessing model 153, and the process proceeds to step S150.

In step S150, the CPU 11 performs OCR processing on the body part which has been subjected to preprocessing in step S144, step S146, step S148, or step S149.

In step S151, the CPU 11 performs the key-value extraction, which is described in FIG. 3 as an example, from the result obtained through OCR processing in step S150, and ends the series of processes according to the information processing program 15A.

According to the third exemplary embodiment, when a header part is not present or header information fails to be obtained from the header part due to influence of noise or the like, the normal mode or the high-accuracy mode is selectable as the mode of preprocessing. Thus, preprocessing, which a user wants to perform, may be applied.

### Fourth Exemplary Embodiment

In a fourth exemplary embodiment, a form in which, when a preprocessing model corresponding to the model obtained from header information is not present, the preprocessing model, having the closest feature information, is selected from the existing preprocessing models, or a corresponding preprocessing model is generated will be described.

Like the image forming apparatus 10 described in the first exemplary embodiment, the CPU 11 of an image forming apparatus (hereinafter referred to as an “image forming apparatus 10C”) according to the fourth exemplary embodiment functions as the acquisition unit 11A, the separation unit 11B, the preprocessor 11C, the recognition unit 11D, the extraction unit 11E, and the switching unit 11F. The differences between the image forming apparatus 10C according to the fourth exemplary embodiment and the image forming apparatus 10 according to the first exemplary embodiment will be described.

Multiple types of preprocessing models (for example, the model-A preprocessing model 151, the model-B preprocessing model 152, and the common preprocessing model 153) are the existing preprocessing models, and are associated with multiple types of header part information in advance.

When a preprocessing model corresponding to the header recognition result obtained from a FAX image is not present among the multiple types of preprocessing models, the preprocessor 11C accumulates a certain number of sets of a header part and its corresponding body part. The preprocessor 11C compares the feature value information of character regions included in the certain number of body parts with the feature value information of character regions included in the body part information corresponding to the existing types of header part information, one type by one type. The preprocessor 11C selects the preprocessing model, which is associated with header part information corresponding to body part information having the closest feature value information of character regions, from the existing types of preprocessing models. As described above, for example, the ratio between white pixels and black pixels is used as feature value information. In this case, when the same type of header recognition result is obtained next time, the switching unit 11F may make switching to the selected preprocessing.

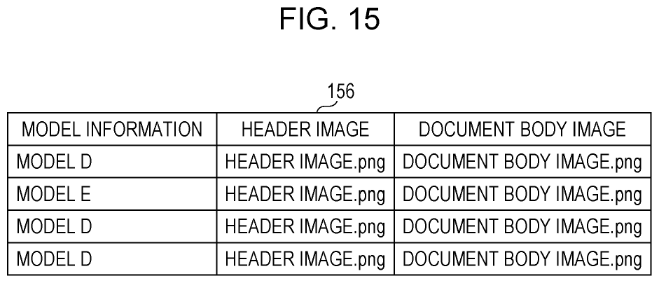

FIG. 15 is a diagram illustrating an exemplary database 156 according to the fourth exemplary embodiment. The database 156 is stored, for example, in the storage unit 15.

When a preprocessing model corresponding to a header recognition result is not present among the existing types of preprocessing models, a set of a header image (header part) and a document body image (body part) is accumulated in association with the model in the database 156 illustrated in FIG. 15. Specifically, for example, when a certain number of sets of a header image and a document body image for model D are accumulated in the database 156, first feature value information of character regions included in the certain number of document body images for model D is derived. In contrast, second feature value information of character regions included in the document body image information corresponding to the existing types of header image information (for example, model A, model B, and common) is derived. The first feature value information is compared with the second feature value information, one type by one type. From the result of the comparison, the preprocessing model, which is associated with header image information corresponding to document body image information having the closest feature value information of character regions, is selected from the existing types of preprocessing models (for example, the model-A preprocessing model 151, the model-B preprocessing model 152, and the common preprocessing model 153).

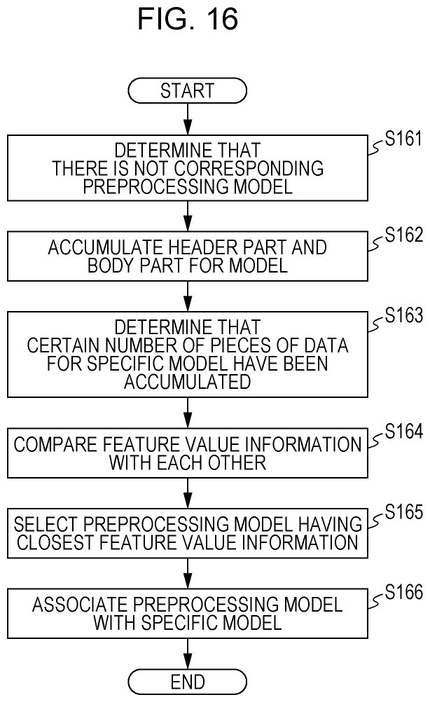

Referring to FIG. 16, the operation of the image forming apparatus 10C according to the fourth exemplary embodiment will be described.

FIG. 16 is a flowchart of an exemplary process performed by using the information processing program 15A according to the fourth exemplary embodiment.

When the image forming apparatus 10C is instructed to select a preprocessing model, the CPU 11 runs the information processing program 15A, and performs the steps described below.

In step S161 in FIG. 16, the CPU 11 determines that there is not a preprocessing model corresponding to the header recognition result obtained from a FAX image.

In step S162, the CPU 11 accumulates the header part and the body part for the model, for example, in the database 156 illustrated in FIG. 15.

In step S163, the CPU 11 determines that a certain number of pieces of data for a specific model have been accumulated in the database 156.

In step S164, the CPU 11 compares the feature value information of character regions included in the certain number of body parts of the specific model with the feature value information of character regions included in the body part information corresponding to the existing types of header part information, one type by one type. Specifically, the first feature value information of character regions included in the certain number of document body images of model D, illustrated in FIG. 15, is derived. In contrast, the second feature value information of character regions included in the document body image information corresponding to the existing types of header image information (for example, model A, model B, and common) is derived. Then, the first feature value information is compared with the second feature value information, one type by one type.

In step S165, the CPU 11 selects the preprocessing model, which is associated with header part information corresponding to body part information having the closest feature value information of character regions, from the existing types of preprocessing models. Specifically, from the result of the comparison, the preprocessing model, which is associated with header image information corresponding to document body image information having the closest feature value information of character regions among the existing types of preprocessing models (for example, the model-A preprocessing model 151, the model-B preprocessing model 152, and the common preprocessing model 153), is selected.

In step S166, the CPU 11 associates the preprocessing model, which is selected in step S165, with the specific model (for example, model D), and ends the series of processes according to the information processing program 15A. Thus, when a FAX image of model D is obtained next time, the selected preprocessing model is applied.

Alternatively, a preprocessing model for a specific model (for example, model D) may be generated. In this case, when a preprocessing model corresponding to the header recognition result obtained from a FAX image is not present among the existing types of preprocessing models, the preprocessor 11C accumulates a certain number of sets of a header part and its corresponding body part. The preprocessor 11C generates, from the certain number of body parts, a preprocessing model corresponding to the header part information. Specifically, for example, when a certain number of sets of a header image and a document body image of model D have been accumulated in the database 156, a preprocessing model corresponding to the header image information is generated from the certain number of document body images of model D. The model-D preprocessing model is a trained model generated through machine learning in association with model D, from which FAX images are transmitted, by using the FAX images and supervised data of model D as training data. The model-D preprocessing model is a model for performing optimum preprocessing on FAX images of model D.

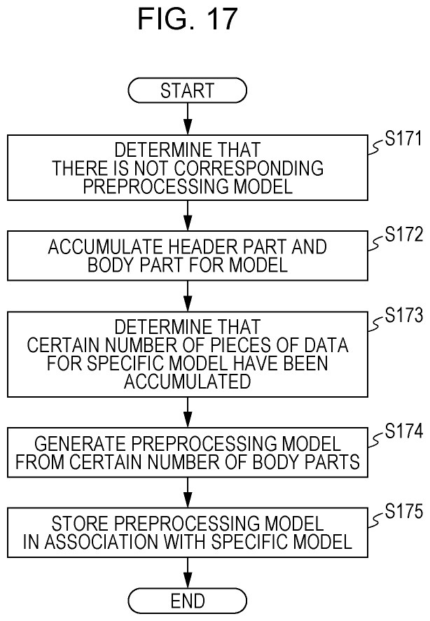

Referring to FIG. 17, the operation of the image forming apparatus 10C according to a modified example of the fourth exemplary embodiment will be described.

FIG. 17 is a flowchart of an exemplary process performed by using the information processing program 15A according to the modified example of the fourth exemplary embodiment.

When the image forming apparatus 10C is instructed to generate a preprocessing model, the CPU 11 runs the information processing program 15A, and performs the steps described below. Specifically, the process is performed when “Automatic learning about preprocessing for addition” is selected on the preprocessing setting screen 162 illustrated in FIG. 9.

In step S171 in FIG. 17, the CPU 11 determines that a preprocessing model corresponding to the header recognition result obtained from a FAX image is not present.

In step S172, the CPU 11 accumulates the header part and the body part in association with the model, for example, in the database 156 illustrated in FIG. 15.

In step S173, the CPU 11 determines that a certain number of sets for a specific model have been accumulated in the database 156.

In step S174, the CPU 11 generates a preprocessing model from the certain number of body parts of the specific model. Specifically, for example, the model-D preprocessing model corresponding to the header image information is generated from the certain number of document body images of model D.

In step S175, the CPU 11 stores the preprocessing model, which is generated in step S175, in association with the specific model (for example, model D), and ends the series of processes according to the information processing program 15A.

According to the fourth exemplary embodiment, when a preprocessing model corresponding to the model obtained from header information is not present, the preprocessing model having the closest feature information is selected from the existing preprocessing models. Thus, even when a corresponding preprocessing model is not present, the preprocessing model having close feature information may be applied.

Alternatively, when a preprocessing model corresponding to the model obtained from header information is not present, a corresponding preprocessing model is newly generated. Thus, even when a corresponding preprocessing model is not present, a corresponding preprocessing model may be applied.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

As an information processing apparatus according to the exemplary embodiments, the image forming apparatuses are described as an example. The exemplary embodiments may be implemented by using programs for causing a computer to perform the functions of the units included in the information processing apparatus. The exemplary embodiments may be implemented by using a computer-readable non-transitory storage medium in which the programs are stored.

In addition, the configuration of the information processing apparatus described in the exemplary embodiments is exemplary, and may be changed in accordance with the state without departing from the gist of the disclosure.

The process flows of the programs described in the exemplary embodiments are exemplary. Deletion of unnecessary steps, addition of new steps, and replacement in the process order may be made without departing from the gist of the present disclosure.

In the exemplary embodiments, the case in which, through execution of the programs, the processes according to the exemplary embodiments are implemented by using a computer and software configuration is described. However, another case may be employed. For example, the exemplary embodiments may be implemented through hardware configuration or a combination of hardware configuration and software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
separate a header part and a body part from a read image obtained by reading a facsimile document which is a document received by facsimile; and
switch preprocessing in accordance with a header recognition result which is a recognition result obtained through character recognition on the header part, the preprocessing being performed before character recognition on the body part.

2. The information processing apparatus according to claim 1,
wherein the processor is configured to:
extract, from the header recognition result, header information which is information included in the header part; and
switch the preprocessing in accordance with the header information.

3. The information processing apparatus according to claim 2,
wherein the header information includes at least one of model information, manufacturer information, or a facsimile number of a transmission-source apparatus from which the facsimile document is transmitted, the model information designating a model of the transmission-source apparatus, the manufacturer information designating a manufacturer of the model.

4. The information processing apparatus according to claim 3,
wherein the header information includes two or more of the model information, the manufacturer information, or the facsimile number, and
wherein the processor is configured to:
extract the header information in an order of the model information, the manufacturer information, and the facsimile number, the order being a predetermined priority order.

5. The information processing apparatus according to claim 1,
wherein the processor is configured to:
perform character recognition on the header part which has been subjected to a plurality of types of the preprocessing; and
select, from the plurality of obtained header recognition results, a header recognition result having a highest recognition accuracy.

6. The information processing apparatus according to claim 2,
wherein the processor is configured to:
perform character recognition on the header part which has been subjected to a plurality of types of the preprocessing; and
select, from the plurality of obtained header recognition results, a header recognition result having a highest recognition accuracy.

7. The information processing apparatus according to claim 3,
wherein the processor is configured to:
perform character recognition on the header part which has been subjected to a plurality of types of the preprocessing; and
select, from the plurality of obtained header recognition results, a header recognition result having a highest recognition accuracy.

8. The information processing apparatus according to claim 4,
wherein the processor is configured to:
perform character recognition on the header part which has been subjected to a plurality of types of the preprocessing; and
select, from the plurality of obtained header recognition results, a header recognition result having a highest recognition accuracy.

9. The information processing apparatus according to claim 5,
wherein the processor is configured to:
select, from the plurality of header recognition results, a header recognition result having a highest confidence factor, the confidence factor indicating the recognition accuracy.

10. The information processing apparatus according to claim 6,
wherein the processor is configured to:
select, from the plurality of header recognition results, a header recognition result having a highest confidence factor, the confidence factor indicating the recognition accuracy.

11. The information processing apparatus according to claim 7,
wherein the processor is configured to:
select, from the plurality of header recognition results, a header recognition result having a highest confidence factor, the confidence factor indicating the recognition accuracy.

12. The information processing apparatus according to claim 8,
wherein the processor is configured to:
select, from the plurality of header recognition results, a header recognition result having a highest confidence factor, the confidence factor indicating the recognition accuracy.

13. The information processing apparatus according to claim 1,
wherein the processor is configured to:
when the header part is not present or header information fails to be obtained from the header part, make a first mode or a second mode selectable, the first mode being a mode in which specific preprocessing is performed on the body part, the second mode being a mode in which the preprocessing is switched in accordance with a feature value of a character region included in the body part.

14. The information processing apparatus according to claim 2,
wherein the processor is configured to:
when the header part is not present or the header information fails to be obtained from the header part, make a first mode or a second mode selectable, the first mode being a mode in which specific preprocessing is performed on the body part, the second mode being a mode in which the preprocessing is switched in accordance with a feature value of a character region included in the body part.

15. The information processing apparatus according to claim 13,
wherein the feature value is expressed as a ratio between white pixels and black pixels in an area obtained by surrounding the character region with a circumscribed rectangle.

16. The information processing apparatus according to claim 1,
wherein the preprocessing is any one of a plurality of types of preprocessing which are associated with a plurality of types of header part information in advance, and wherein the preprocessor is configured to:
when preprocessing corresponding to the obtained header recognition result is not present among the plurality of types of preprocessing, accumulate a certain number of sets of the header part and the corresponding body part;
compare first feature value information with second feature value information, one type by one type, the first feature value information being feature value information of character regions included in the certain number of body parts, the second feature value information being feature value information of character regions included in body part information corresponding to the plurality of types of header part information; and
select preprocessing from the plurality of types of preprocessing, the selected preprocessing being associated with header part information corresponding to body part information having closest feature value information of character regions.

17. The information processing apparatus according to claim 16,
wherein the processor is configured to:
when the header recognition result is obtained next time, make switching to the selected preprocessing.

18. The information processing apparatus according to claim 1,
wherein the preprocessing is any one of a plurality of types of preprocessing associated with a plurality of types of header part information in advance, and
wherein the processor is configured to:
when preprocessing corresponding to the obtained header recognition result is not present among the plurality of types of preprocessing, accumulate a certain number of sets of the header part and the corresponding body part; and
generate, from the certain number of body parts, preprocessing corresponding to header part information.

19. A non-transitory computer readable medium storing a program causing a computer to execute a process for information processing, the process comprising:
separating a header part and a body part from a read image obtained by reading a facsimile document which is a document received by facsimile; and
switching preprocessing in accordance with a header recognition result which is a recognition result obtained through character recognition on the header part, the preprocessing being performed before character recognition on the body part.

20. An information processing method comprising:
separating a header part and a body part from a read image obtained by reading a facsimile document which is a document received by facsimile; and
switching preprocessing in accordance with a header recognition result which is a recognition result obtained through character recognition on the header part, the preprocessing being performed before character recognition on the body part.
